(19) United States
(12) Patent Application Publication
(10) Pub. No.: US 2004/0163287 A1
(43) Pub. Date: Aug. 26, 2004

(54) ATV license plate mounting system

(76) Inventor: Michael E. Swartz, Milroy, PA (US)

Correspondence Address: MICHAEL E. SWARTZ, 115 MAPLE ST., MILROY, PA, 17063, US

(21) Appl. No.: 10/372,599

(22) Filed: Feb. 25, 2003

(51) Int. Cl. G09F 7/00

(52) U.S. Cl. 40/209

(57) ABSTRACT

The device is a license plate mounting system, particularly a license plate Mounting system that includes a license plate holder and mounting straps, which is easily Installed as an aftermarket or factory-installed product to the rear grab bar of an all-Terrain vehicle (ATV) or all-terrain cycle (ATC), and can also be adapted for use by golf Carts and other vehicles. It would be fabricated from a strong, weather-resistant material Such as metal, plastic, or hard rubber.

### BACKGROUND OF INVENTION

1. Field of the Invention

The invention generally relates to a license plate mounting system, Particularly a license plate mounting system that is easily installed as an aftermarket or a Factory-installed product for an all-terrain vehicle (ATV) or all-terrain cycle (ATC), and Can also be adapted for use by golf carts and other vehicles.

2. Brief Description of Prior Art

U.S. Pat. No. 4,182,062 describes a license plate lockbox assembly to be Secured to the rear license plate of a motor vehicle. U.S. Pat. No. 5,392,619 describes Lockable license plate holder to prevent theft of a an automobile license plate. U.S. Pat. No. 5,404,664 is a security frame for preventing a theft or unauthorized removal of a License plate from a vehicle. U.S. Pat. No. 6,478,458 describes a motorcycle license plate Frame from having an illuminated message bar. U.S. Pat. No. 5,012,602 describes a Locking license plate holder for mounting license plates on automobiles, trucks and Trailers. U.S. Pat. No. 4,958,451 describes a motorcycle rear license plate assembly and Lamp separate from tail light, to facilitate placement of the license plate at a more readily Viewable position. U.S. Pat. No. 5,813,640 describes a removable license plate holder And mounting system, to attach and overhang from a truck, automobile or bus bumper Or grill.

The above referenced material does not adequately describe the invention

### SUMMARY OF THE INVENTION

Many consumers often alternative methods and transportation, Especially when they are traveling through off-road areas. For example, mountain Bikes are often used on bike trails that are situated in remote areas. Similarly, Vehicles like all-terrain vehicles (ATV's) have become very popular for Recreational use outdoors as well as for work use on farms and homes with Substantial property.

Motorcycles are purchased with the license plate holder already mounted, Since they come in on-road, or street bike; off-road, or dirt bike; and on-road/off-road Combination models.

Snowmobiles only use a sticker instead a physical license plate.

However, ATV's do not come equipped with a built-in license plate holder That is already mounted on the vehicle. In recent years, more and more states have been Requiring owners of ATV's to get licenses. They are difficult, if not dangerous, to secure Properly and there is no uniformity among where they are placed and how they are Attached. To the ATV. Many ATV owners resort to using screws to fasten their license Plates to rear of the ATV, which can cause vehicle damage and be attached at an Angle or position that is difficult to read, and there is nothing keeping the screw from Coming loose.

A new invention, ATV LICENSE PLATE MOUNTING SYSTEM, would Provide a convenient license plate holder secured to mounting straps, which would hold A license plate secure and easily attached to most existing and new ATV models. It will Eliminate the necessity of attempting to fasten the license plate directly onto an ATV., be More secure by permitting the use of fasteners such as bolts and nuts in the place of Screws, and bring uniformity by allowing the license plates to hang true in Practically the same area of most ATV's.

### BRIEF DESCRIPTION OF DRAWINGS

FIG. 1 is a front view of ATV license plate mounting system.

FIG. 2 is a side view of ATV license plate mounting system.

### DETAILED DESCRIPTION OF PREFERRED EMBODIMENTS

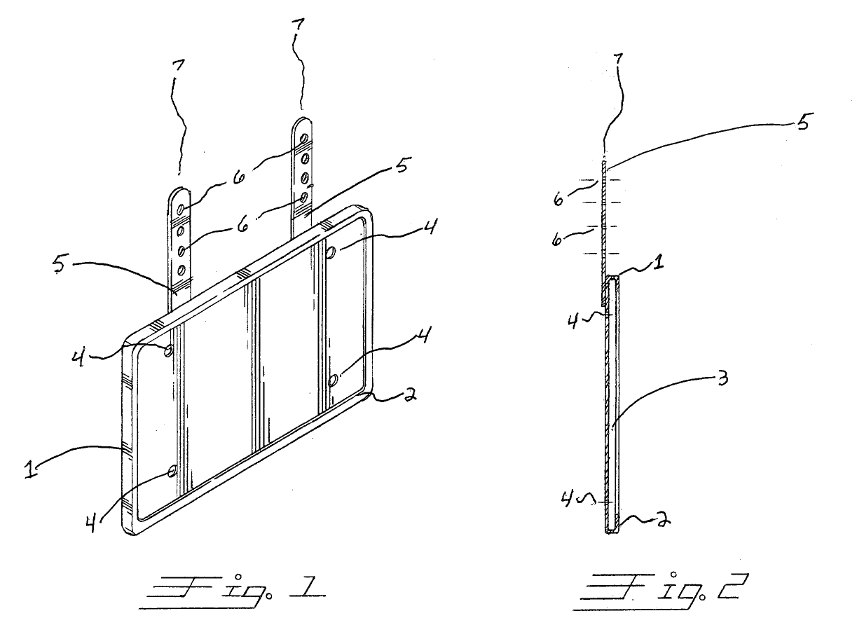

#1 of FIG. 1 shows the front view of the ATV license plate holder. It Would be rectangular in shape to hold a standard ATV license plate. It would be Fabricated from a durable, weather-resistant plastic, corrosion-resistant metal, hard Rubber or other maternal.

#2 of FIG. 1 shows raised rim around outside edge of license plate holder. This raised rim would be at least the height of the thickness of the license plate, and Would add strength and prevent the license plate edges from being damaged. Including a Wire reinforcement is also an option to add additional strength to the rim.

#3 of FIG. 1 shows area where license plate is inserted into holder.

#4 of FIG. 1 shows holes where fasteners secure plate to holder.

#5 of FIG. 1 shows mounting straps. It could include reflective strips which May be especially useful in early morning or early evening hours.

#6 of FIG. 1 shows holes where fasteners secure strap to rear grab bar or Foreign rear grab bar.

#7 of FIG. 1 points toward rear grab bar or foreign rear grab bar.

#1 of FIG. 2 shows the side view of the ATV license plate holder.

#2 of FIG. 2 shows raised rim around outside edge of license plate holder.

#3 of FIG. 2 shows area where license plate is inserted into holder.

#4 of FIG. 2 shows holes where fasteners secure plate to holder.

#5 of FIG. 2 shows mounting straps.

#6 of FIG. 2 shows holes where fasteners secure strap to rear grab bar or Foreign rear grab bar.

#7 of Rig.2 points towards rear grab bar or foreign rear grab bar.

I claim:

1. An ATV license plate mounting system, that holds a standard ATV license plate and Easily attaches to the rear grab bar or foreign rear grab bar of an ATV or ATC.

2. An ATV license plate mounting system as described in claim 1, with a fabricated Rectangular license plate holder that includes mounting holes and a raised rim around the Outside edge;

3. An ATV license plate mounting system as described in claim 1, with mounting straps Secured to the license plate holder that attach to the rear grab bar or foreign rear grab bar Of an ATV or ATC;

4. An ATV license plate mounting system as described in claim 1, where mounting Straps are reflective;

5. An ATV license plate mounting system described in claim 1, which is adapted to Be used on a golf cart or other vehicle.
